(19) United States
(12) Patent Application Publication
(10) Pub. No.: US 2020/0310821 A1
(43) Pub. Date: Oct. 1, 2020

(54) INFORMATION PROCESSING APPARATUS, CONTROL METHOD THEREFOR, AND STORAGE MEDIUM

(71) Applicant: CANON KABUSHIKI KAISHA, Tokyo (JP)

(72) Inventors: Takumi Michishita, Nagareyama-shi (JP); Yoshiharu Ito, Toride-shi (JP)

(21) Appl. No.: 16/810,049

(22) Filed: Mar. 5, 2020

(30) Foreign Application Priority Data
Mar. 26, 2019 (JP) 2019-058902

(51) Int. Cl. G06F 9/4401; G06F 3/06

(52) U.S. Cl. CPC G06F 9/4401; G06F 3/0679; G06F 3/0604; G06F 3/0655

(57) ABSTRACT

An information processing apparatus comprises a storage that stores at least a first boot program and a second boot program; a first controller that judges whether the first boot program stored in the storage is normal and whether the second boot program stored in the storage is normal; and a second controller that executes a boot program judged to be normal by the first controller, wherein upon judging that a second boot program is normal by the first controller, after judging that a first boot program is abnormal, the second controller executes the second boot program, and after the second controller executes the second boot program judged to be normal by the first controller, the first controller overwrites, in the storage, the first boot program judged to be abnormal with the second boot program judged to be normal.

### BACKGROUND OF THE INVENTION

### Field of the Invention

The present invention relates to an information processing apparatus, a control method therefor, and a storage medium.

### Description of the Related Art

Non-volatile memories are widely used as a storage location for system activation programs (boot programs), although unintended changes sometimes occur in the contents of such non-volatile memories. Bit changes occurring due to charge leakage caused by aged deterioration resulting from physical defects in the non-volatile memory is given as one cause of an unintended change in a boot program. Rewriting (alteration) of a boot program due to an electronic attack by a malicious attacker is given as another cause. When such changes occur in a boot program, unintended operations may be performed, such as a system failing to activate or information being leaked by a program that has been rewritten by an attacker.

There are technologies for verifying the occurrence of a change in a boot program at the time of power on (activation), in order to avoid such cases and ensure that a normal boot program is operated. For example, Japanese Patent Laid-Open No. 2010-26650 proposes a technology that stores a plurality of boot programs in a non-volatile memory, verifies the occurrence of a change in the boot programs at the time of activation, and, in the case where a change is detected, recovers the boot program from a backup non-volatile memory.

However, there is the following problem with the above conventional technology. For example, with the above conventional technology, it is possible to detect the corruption of a main boot program and to perform restoration processing of the contents of a backup non-volatile memory to an original state. However, the time taken in the restoration processing and the influence on the activation time are not taken into consideration. With the above conventional technology, two identical boot programs are provided, and when alteration is detected at the time of power on, copying is started from whichever of the two boot programs is normal, and execution of the system is started after copying is completed. With such a configuration, the copy processing for recovery takes time, extending the time until the system starts operating and reducing convenience to the user.

### SUMMARY OF THE INVENTION

The present invention enables realization of a mechanism that favorably performs activation with a normal boot program without impairing convenience to a user, even if there an abnormality in any of a plurality of boot programs.

One aspect of the present invention provides an information processing apparatus comprising: a storage that stores at least a first boot program and a second boot program; a first controller that judges whether the first boot program stored in the storage is normal and whether the second boot program stored in the storage is normal; and a second controller that executes a boot program judged to be normal by the first controller, wherein upon judging that a second boot program is normal by the first controller, after judging that a first boot program is abnormal, the second controller executes the second boot program, and after the second controller executes the second boot program judged to be normal by the first controller, the first controller overwrites, in the storage, the first boot program judged to be abnormal with the second boot program judged to be normal.

Another aspect of the present invention provides a control method for an information processing apparatus that includes a storage that stores at least a first boot program and a second boot program, a first controller that judges whether the first boot program stored in the storage is normal and whether the second boot program stored in the storage is normal, and a second controller that executes a boot program judged to be normal by the first controller, the control method comprising: upon judging that a second boot program is normal by the first controller, after judging that a first boot program is abnormal, the second controller executes the second boot program, and after the second controller executes the second boot program judged to be normal by the first controller, the first controller overwrites, in the storage, the first boot program judged to be abnormal with the second boot program judged to be normal.

Still another aspect of the present invention provides a non-transitory computer-readable storage medium storing a computer program for causing a computer to execute the steps of a control method for an information processing apparatus that includes a storage that stores at least a first boot program and a second boot program, a first controller that judges whether the first boot programs stored in the storage is normal and whether the second boot program stored in the storage is normal, and a second controller that executes a boot program judged to be normal by the first controller, the control method comprising: upon judging that a second boot program is normal by the first controller, after judging that a first boot program is abnormal, the second controller executes the second boot program, and after the second controller executes the second boot program judged to be normal by the first controller, the first controller overwrites, in the storage, the first boot program judged to be abnormal with the second boot program judged to be normal.

Further features of the present invention will become apparent from the following description of exemplary embodiments (with reference to the attached drawings).

### BRIEF DESCRIPTION OF THE DRAWINGS

FIG. 1 is a diagram showing a hardware configuration of a multifunction machine according to one embodiment.

FIGS. 2A and 2B are diagrams showing a functional configuration of the multifunction machine according to one embodiment.

FIG. 3 is a flowchart showing an example of activation processing according to one embodiment.

FIG. 4 is a flowchart showing an example of processing at the time of an abnormality in the activation processing according to one embodiment.

FIG. 5 is a flowchart showing an example of restoration processing of a boot program for the activation processing according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

Note that a multifunction machine (digital multifunction machine/MFP/multifunction peripheral) will be described as an example information processing apparatus according to the embodiments. However, the device to which the present invention is applied is not limited to a multifunction machine, and need only be an information processing apparatus.

Hardware Configuration

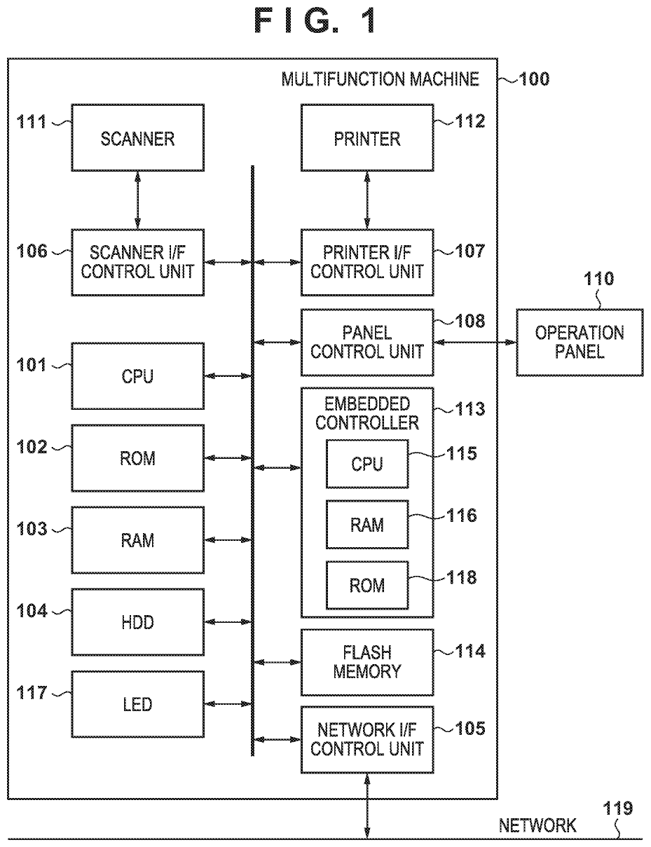

Hereinafter, one embodiment of the present invention will be described. First, hardware configurations of a multifunction machine 100 according to one embodiment and an embedded controller 113 will be described, with reference to FIG. 1.

The multifunction machine 100 is provided with a CPU 101, a ROM 102, a RAM 103, a HDD (Hard Disk Drive) 104, an LED (Light Emitting Diode) 117, and a flash memory 114. Also, the multifunction machine 100 is provided with a network I/F control unit 105, a scanner I/F control unit 106, a scanner 111, a printer I/F control unit 107, a printer 112, a panel control unit 108, an operation panel 110, and an embedded controller 113. Also, the embedded controller 113 is provided with a CPU 115, a RAM 116, and a ROM 118.

The CPU 101 executes a software program of the multifunction machine 100, and performs overall device control. The ROM 102 is a read-only memory and stores a BIOS, fixed parameters and the like of the multifunction machine 100. The RAM 103 is random access memory, and is used for program and temporary data storage and the like, when the CPU 101 controls the multifunction machine 100. The HDD 104 is a hard disk drive, and stores some of the applications and various data. The flash memory 114 stores a loader, a kernel, and applications.

On the other hand, the CPU 115 executes a software program of the embedded controller 113, and controls part of the multifunction machine 100. The RAM 116 is a random access memory, and is used for program and temporary data storage and the like, when the CPU 115 controls the multifunction machine 100. The ROM 118 stores a program that is initially read out when the CPU 115 starts operating.

The network I/F control unit 105 controls data transmission to and reception from the network 119. The scanner I/F control unit 106 controls reading of manuscripts by the scanner 111. The printer I/F control unit 107 controls print processing by the printer 112 and the like. The panel control unit 108 controls the touch-sensitive operation panel 110, and controls display of various information and input of instructions by a user. A bus 109 connects the CPU 101, the ROM 102, the RAM 103, the HDD 104, the network I/F control unit 105, the scanner I/F control unit 106 and the printer I/F control unit 107 to each other. Furthermore, the bus 109 also connects the panel control unit 108, the embedded controller 113 and the flash memory 114 to each other. Control signals from the CPU 101 and data signals between the devices are transmitted and received by respective units, via this bus 109. The LED 117 turns on when necessary, and is utilized in order to externally convey software and hardware abnormalities.

Functional Configuration

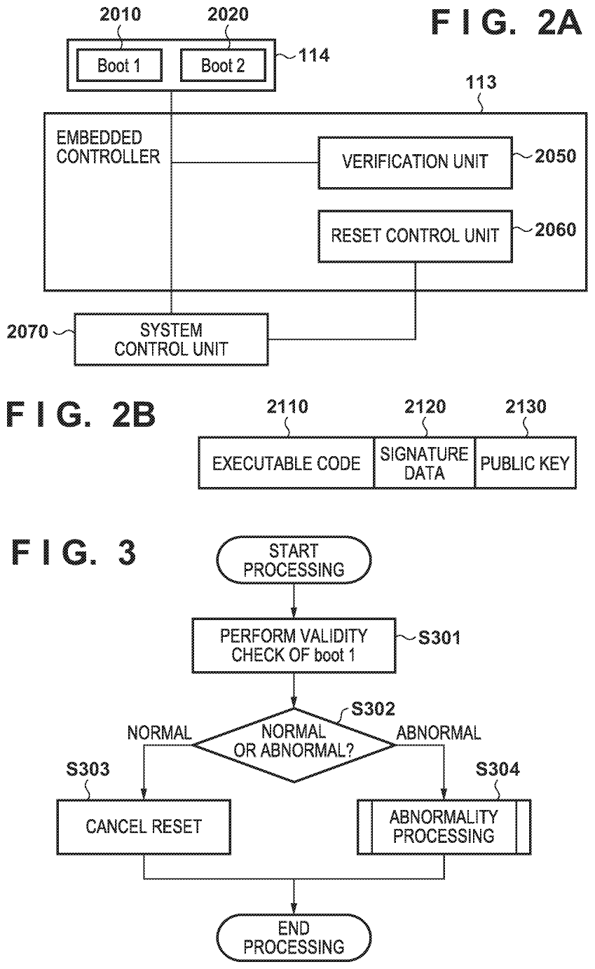

Next, a functional configuration of the multifunction machine 100 according to one embodiment will be described, with reference to FIGS. 2A and 2B. FIG. 2A shows a functional configuration of the multifunction machine 100 according to one embodiment.

A boot program (Boot 1, first boot program) 2010 and a boot program (Boot 2, second boot program) 2020 are stored in the flash memory 114. A plurality of functions are included within the embedded controller 113. In the present embodiment, as shown in FIG. 1, the flash memory 114 and the embedded controller 113 are connected by the common bus 109. However, the present invention is not intended to be limited to this configuration, and, rather than using the bus 109 in reading and writing of data of the flash memory 114 by the embedded controller 113, a bus directly connecting the flash memory 114 and the embedded controller 113 may be separately provided for use.

The embedded controller 113 includes a verification unit 2050 and a reset control unit 2060. The verification unit 2050 checks whether there has been an unintended change in the boot programs. Use of an electronic signature technology applying a public key encryption system that is generally widely used is envisioned. Thus, a detailed description thereof will be omitted. The reset control unit 2060 controls a reset state of a system control unit 2070 which will be discussed later. An initial state is the reset state.

The system control unit 2070 corresponds to the entirety of the multifunction machine 100 other than the flash memory 114 and the embedded controller 113 shown in FIG. 1. As aforementioned, the reset control unit 2060 does not start operating even when power supply is started, since the initial state is the reset state.

FIG. 2B shows a logical configuration of the boot programs 2010 and 2020 that are stored in the flash memory 114. As aforementioned, the boot programs 2010 and 2020 include not only the program body but also additional information, in order to detect unintended changes using an electronic signature technology that applies a public key encryption system. An executable code 2110 is a program body that is executed by the CPU. Signature data 2120 and a public key 2130 are additional information that is required in order to verify the validity of the executable code 2110. The boot programs 2010 and 2020 each include the signature data 2120 and the public key 2130. Note that this additional information is updatable, and thus can be updated to new additional information, in the case where, for example, alteration of the executable code 2110 or the like is detected, since there is a possibility of the additional information having leaked. Also, the additional information for verifying the validity of the executable code 2110 could itself possibly be altered or could also possibly change over time, and is thus configured to be updatable in view also of such cases. Note that since the additional information could itself also possibly change, information for verifying the additional information is desirably stored in a non-rewritable memory.

Processing at Power On

Next, the processing procedure of selection processing that is executed by the embedded controller 113 when the multifunction machine 100 according to one embodiment is powered on will be described, with reference to FIG. 3. The processing described below is, for example, realized by the CPU 115 of the embedded controller 113 reading out a program that has been stored in advance in the ROM 118 as software to the RAM 116 and executing the program.

At the time when the multifunction machine 100 is powered on, the CPU 115, in step S301, checks the validity of the boot program (Boot 1) 2010 for unintended changes (verification processing). Note that, in the present embodiment, since checking is performed using an electronic signature technology that applies a public key encryption system, as aforementioned, a detailed description of the verification processing will be omitted.

Next, in step S302, the CPU 115 evaluates the result of the validity check in step S301, and if the result is normal, the processing advances to step S303, and if the result is abnormal, the processing advances to step S304. In step S303, the CPU 115 cancels the reset state with the reset control unit 2060. Upon the reset state being canceled, the system control unit 2070 reads out the boot program 2010 and starts activation processing.

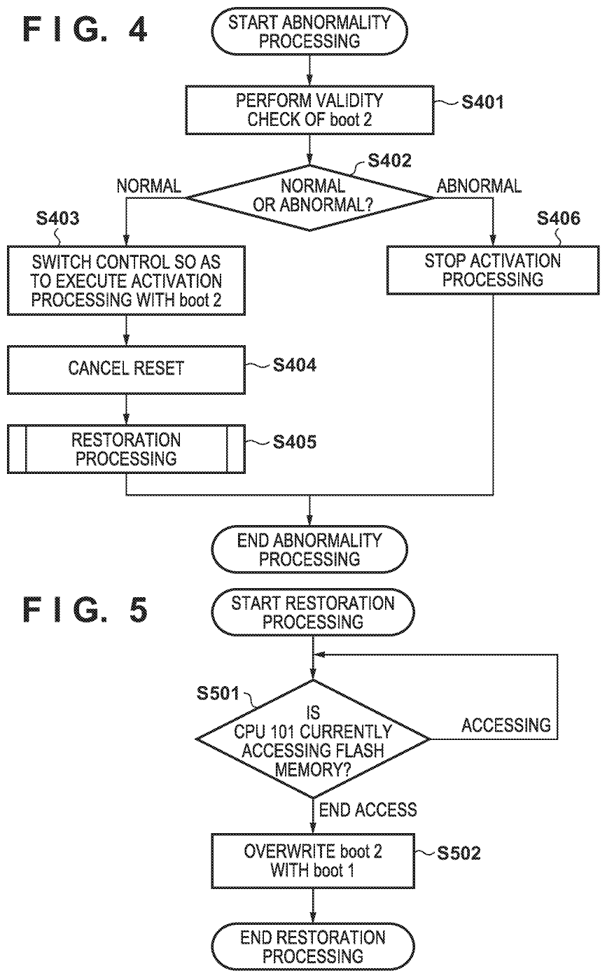

On the other hand, in step S304, the CPU 115 executes abnormality processing, since the result of the validity check is abnormal. The abnormality processing that is executed in step S304 will be described in detail with FIG. 4.

Abnormality Processing

Next, the processing procedure of the abnormality processing (step S304) according to one embodiment will be described, with reference to FIG. 4. The processing described below is, for example, realized by the CPU 115 of the embedded controller 113 reading out a program that has been stored in advance in the ROM 118 as software to the RAM 116 and executing the program.

In step S401, the CPU 115 checks that validity of the boot program 2020 for unintended changes (verification processing). Then, in step S402, the CPU 115 evaluates the result of the validity check in step S401. If the result is normal, the processing advances to step S403, and if the result is abnormal, the processing advances to step S406.

In step S403, the CPU 115 reads out the normal boot program 2020 and switches control of the system control unit 2070 so as to start activation processing. Then, in step S404, the CPU 115 cancels the reset state with the reset control unit 2060. Here, upon the reset state being canceled, the system control unit 2070 reads out the boot program 2020 and starts operating (activation processing). In terms of timing, this activation processing is performed immediately after the processing of step S404 by the CPU 115. Note that the activation processing may be performed in parallel with the processing of step S405 by the CPU 115 which will be discussed later, or may be performed before the processing of step S405. In other words, in the present embodiment, control is performed such that the activation processing is not delayed due to the influence of the restoration processing.

At the timing of step S404, the boot program 2010 is abnormal and the boot program 2020 is normal. Here, the multifunction machine 100 according to the present embodiment prepares for the following activation processing, by ensuring that both boot programs are maintained in a normal state. Accordingly, in step S405, the CPU 115 executes the restoration processing of the boot program 2010, and ends the above processing. In order to ensure, however, that the activation time of the system control unit 2070 is not affected, the restoration processing in step S405 is controlled to be processed in parallel in the background of the activation processing. The processing of step S405 will be described in detail with FIG. 5.

On the other hand, in step S406, the CPU 115 stops the activation processing and ends the above processing, since it is judged in step S402 that the result of the validity check of the boot program 2020 is abnormal. In this case, since both of the two boot programs are judged to be abnormal, reset is not canceled, and the system control unit 2070 does not start operating. When the activation processing is stopped in step S406, the CPU 115 may change the LED 117 to a lighted state, and report that the system control unit 2070 was not able to start operating.

Restoration Processing

Next, the processing procedure of the restoration processing (step S405) according to one embodiment will be described, with reference to FIG. 5. The processing described below is, for example, realized by the CPU 115 of the embedded controller 113 reading out a program that has been stored in advance in the ROM 118 as software to the RAM 116 and executing the program.

As also described with FIG. 4, the restoration processing according to the present embodiment is controlled to be processed in parallel in the background of the activation processing. Accordingly, in the present embodiment, the CPU 115 within the embedded controller 113 and the CPU 101 within the system control unit 2070 could possibly access the flash memory 114 at the same time. Since the signal line for accessing the flash memory 114 is shared by CPUs in most cases, it is envisioned that the CPUs will compete for access to the flash memory 114. In view of this, in the restoration processing according to the present embodiment, such competition for access is prevented, in order to conduct access to the flash memory 114 normally.

In step S501, the CPU 115 checks whether the CPU 101 is currently accessing the flash memory 114. With regard to whether the flash memory 114 is currently being accessed, a configuration may be adopted in which information, referable by both the CPU 101 and the CPU 115, indicating whether the CPU 101 is currently accessing the RAM 103 or has ended access is updated, and the CPU 115 need only refer to this information. This information may be provided as flag information.

In the case where the CPU 115 determines in step S501 that the flash memory 114 is currently being accessed, the CPU 115 returns the processing to step S501 again, and checks whether the CPU 101 is currently accessing the flash memory 114 (retry processing). This retry processing may be controlled to be performed periodically at a predetermined time interval. In the case where the CPU 115 determines that access has ended, the processing advances to step S502.

In step S502, the CPU 115 performs restoration processing of the boot program 2010 judged to be abnormal in step S301, by overwriting the contents of the boot program (Boot 1) 2010 with the contents of the boot program (Boot 2) 2020. The processing of this flowchart is ended upon overwriting being completed.

The restoration processing shown in FIG. 5 was described as being implemented as background processing in parallel with the boot program. However, depending on the functional configuration, control may be performed to execute the restoration processing after activation of the system (activation processing) is entirely completed and general functions of the multifunction machine 100 such as scan and print have become operational. In the case where, however, the system stops or a power supply failure or the like occurs during the activation processing, it becomes difficult to maintain two boot programs in a normal state, and thus it is desirable to execute the restoration processing as speedily as possible.

As described above, the information processing apparatus of the present embodiment is provided with a storage that stores a plurality of boot programs, a first controller that verifies the validity of the boot programs, and a second controller that executes activation processing of the information processing apparatus using a boot program judged to be normal. Also, the first controller (CPU 115), upon judging that the second boot program is normal after judging that the first boot program is abnormal, among the plurality of boot programs, causes the activation processing by the second controller (CPU 101) to be started using the second boot program. Furthermore, the first controller executes restoration processing for overwriting the first boot program judged to be abnormal with the second boot program judged to be normal, in the storage (flash memory 114), after the second controller starts the activation processing. In this way, the information processing apparatus, having detected that one of two boot programs is corrupt, uses the other boot program in system activation if that other boot program is normal. The activation processing can thereby be executed normally and speedily, even in the case where the corruption of a boot program is detected. Also, since restoration processing of the boot program detected as being abnormal is executed in the background, after starting the activation processing of the system using the boot program judged to be normal, an increase in the system activation time can be prevented. Therefore, according to the present embodiment, even if there is an abnormality in any of a plurality of boot programs, activation with a normal boot program can be favorably executed without impairing convenience to the user. Furthermore, a boot program with an abnormality can be restored (updated) without affecting the activation processing.

The present invention is not limited to the above embodiment and various variations can be made. For example, the above embodiment described an example in which only the embedded controller 113 starts operating at the time of power on, and the system control unit 2070 starts operating after the selection processing shown in FIG. 3 is performed. However, the present invention is not limited to such a control, and a configuration may be adopted in which, for example, the embedded controller 113 is not provided, and the CPU 101 within the system control unit 2070 performs the selection processing shown in FIG. 3. In this case, a similar effect can be obtained if the processing shown in FIG. 3 is stored in the ROM 102 and this processing is always executed when the CPU 101 starts operating.

Also, the above embodiment described processing in the case where there are two boot programs, but the present invention is also applicable in the case where there are three or more boot programs. By adopting such a configuration, it becomes possible to further improve resistance. By verifying the validity of all of the plurality of boot programs, not being aware of unauthorized changes to boot programs that are not required to be used in system activation can be prevented.

Also, after starting operation of the system using a boot program judged to be normal, the validity of the other boot programs may be checked in the background. Since detection of abnormalities and restoration processing are executed in background processing, an increase in the system activation time can be prevented. In this way, it becomes possible to improve resistance to unauthorized changes to data in a non-volatile memory, without impairing convenience to the user.

According to the present invention, even if there is an abnormality in any of a plurality of boot programs, activation with a normal boot program can be favorably performed without impairing convenience to the user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-058902, filed Mar. 26, 2019, which is hereby incorporated by reference herein in its entirety.

What is claimed is:

1. An information processing apparatus comprising:
a storage that stores at least a first boot program and a second boot program;
a first controller that judges whether the first boot program stored in the storage is normal and whether the second boot program stored in the storage is normal; and
a second controller that executes a boot program judged to be normal by the first controller,
wherein
upon judging that a second boot program is normal by the first controller, after judging that a first boot program is abnormal, the second controller executes the second boot program, and
after the second controller executes the second boot program judged to be normal by the first controller, the first controller overwrites, in the storage, the first boot program judged to be abnormal with the second boot program judged to be normal.

2. The information processing apparatus according to claim 1,
wherein the first controller overwrites, in the storage, the first boot program judged to be abnormal with the second boot program judged to be normal in a background, in parallel with the second controller executing the second boot program.

3. The information processing apparatus according to claim 2,
wherein the first controller overwrites, in the storage, the first boot program judged to be abnormal with the second boot program judged to be normal after confirming that the second controller is not accessing the storage.

4. The information processing apparatus according to claim 3, further comprising:
another storage that stores a program and information that are used after the second controller executes a boot program,
wherein the other storage further stores information indicating whether or not the second controller is accessing the storage.

5. The information processing apparatus according to claim 1,
wherein the first controller overwrites, in the storage, the first boot program judged to be abnormal with the second boot program judged to be normal, after the second controller executes a boot program.

6. The information processing apparatus according to claim 1,
wherein
upon judging that the first boot program is normal by the first controller, the second controller executes the first boot program, and
after the second controller executes the first boot program judged to be normal by the first controller, the first controller judges that whether the second boot program stored in the storage is normal and, upon judging that the second boot program is abnormal, overwrites the second boot program judged to be abnormal with the first boot program.

7. The information processing apparatus according to claim 1,
wherein the first controller is an embedded controller, and
the second controller is a system control unit configured to control the information processing apparatus.

8. The information processing apparatus according to claim 1,
wherein the storage is a non-volatile memory.

9. The information processing apparatus according to claim 1,
wherein the first boot program and the second boot program are identical boot programs.

10. A control method for an information processing apparatus that includes a storage that stores at least a first boot program and a second boot program, a first controller that judges whether the first boot program stored in the storage is normal and whether the second boot program stored in the storage is normal, and a second controller that executes a boot program judged to be normal by the first controller, the control method comprising:
upon judging that a second boot program is normal by the first controller, after judging that a first boot program is abnormal, the second controller executes the second boot program, and
after the second controller executes the second boot program judged to be normal by the first controller, the first controller overwrites, in the storage, the first boot program judged to be abnormal with the second boot program judged to be normal.

11. A non-transitory computer-readable storage medium storing a computer program for causing a computer to execute the steps of a control method for an information processing apparatus that includes a storage that stores at least a first boot program and a second boot program, a first controller that judges whether the first boot programs stored in the storage is normal and whether the second boot program stored in the storage is normal, and a second controller that executes a boot program judged to be normal by the first controller, the control method comprising:
upon judging that a second boot program is normal by the first controller, after judging that a first boot program is abnormal, the second controller executes the second boot program, and
after the second controller executes the second boot program judged to be normal by the first controller, the first controller overwrites, in the storage, the first boot program judged to be abnormal with the second boot program judged to be normal.
